(19) United States
(12) Patent Application Publication
(10) Pub. No.: US 2015/0235621 A1
(43) Pub. Date: Aug. 20, 2015

(54) Image Processing Method and Device

(71) Applicant: Huawei Technologies Co., Ltd., Shenzhen (CN)

(72) Inventors: Tao Hao, Shenzhen (CN); Kunlong Zuo, Beijing (CN)

(21) Appl. No.: 14/704,266

(22) Filed: May 5, 2015

Related U.S. Application Data
(63) Continuation of application No. PCT/CN2013/086527, filed on Nov. 5, 2013.

(30) Foreign Application Priority Data
Nov. 5, 2012 (CN) 201210435840.1

(51) Int. Cl. G09G 5/10; G06T 3/00; G06K 9/46; G06K 9/52

(52) U.S. Cl. CPC G09G 5/10; G06K 9/52; G06T 3/00; G06K 9/46; G06K 2009/4666

(57) ABSTRACT

An image processing method and device are provided. The method includes determining at least one block covered by a mask and in a current frame image, the at least one block is obtained by dividing the current frame image; determining a pixel mean value of each block, and determining, according to the pixel mean value, a grayscale mapping curve function corresponding to each block; determining a ratio of an area of a part covered by the mask and in each block of the at least one block to an area of the mask; and determining an adjusted pixel value of the first pixel according to the ratio of the area of the part covered by the mask and in each block to the area of the mask, the grayscale mapping curve function corresponding to each block, and an original pixel value of the first pixel.

### CROSS-REFERENCE TO RELATED APPLICATIONS

This application is a continuation of International Application No. PCT/CN2013/086527, filed on Nov. 5, 2013, which claims priority to Chinese Patent Application No. 201210435840.1, filed on Nov. 5, 2012, both of which are hereby incorporated by reference in their entireties.

### TECHNICAL FIELD

The present invention relates to the field of images, and in particular, to an image processing method and device.

### BACKGROUND

Due to an insufficient dynamic range of a display device, generally a captured image cannot be displayed perfectly. When shadow details are displayed, highlight details are lost, and when highlight details are displayed, shadow details are lost. As a result, shadow details and highlight details generally cannot be displayed simultaneously.

To obtain a better image effect, a common processing method used currently is a partial adjustment method, that is, a mask is used to process an image. The image processed in this way presents details well, and has high local contrast. However, in this method, normalization processing needs to be performed on pixels in the mask, and therefore, the method is complex and occupies a lot of resources, which seriously reduces an image processing speed.

### SUMMARY

Embodiments of the present invention provide an image processing method and device, which can save resources and increase an image processing speed.

According to a first aspect, an image processing method is provided and includes determining at least one block covered by a mask and in a current frame image, where the mask uses a first pixel in the current frame image as a center, the at least one block is obtained by dividing the current frame image, and the block includes multiple pixels; determining a pixel mean value of each block of the at least one block, and determining, according to the pixel mean value of each block of the at least one block, a grayscale mapping curve function corresponding to each block of the at least one block; determining a ratio of an area of a part covered by the mask and in each block of the at least one block to an area of the mask; and determining an adjusted pixel value of the first pixel according to the ratio of the area of the part covered by the mask and in each block of the at least one block to the area of the mask, the grayscale mapping curve function corresponding to each block of the at least one block, and an original pixel value of the first pixel.

With reference to the first aspect, in a first possible implementation manner, the determining a pixel mean value of each block of the at least one block, and determining, according to the pixel mean value of each block of the at least one block, a grayscale mapping curve function corresponding to each block of the at least one block includes acquiring a pixel mean value of a block in a previous frame image and corresponding to each block of the at least one block; using the pixel mean value of the block in the previous frame image and corresponding to each block of the at least one block as the pixel mean value of each block of the at least one block; and determining, according to the pixel mean value of each block of the at least one block, the grayscale mapping curve function corresponding to each block of the at least one block.

With reference to the first aspect, in a second possible implementation manner, the determining a pixel mean value of each block of the at least one block, and determining, according to the pixel mean value of each block of the at least one block, a grayscale mapping curve function corresponding to each block of the at least one block includes collecting statistics on pixel values of all pixels of each block of the at least one block, to determine the pixel mean value of each block of the at least one block; and determining, according to the pixel mean value of each block of the at least one block, the grayscale mapping curve function corresponding to each block of the at least one block.

With reference to the first aspect, in a third possible implementation manner, the determining a pixel mean value of each block of the at least one block, and determining, according to the pixel mean value of each block of the at least one block, a grayscale mapping curve function corresponding to each block of the at least one block includes determining the pixel mean value of each block of the at least one block; when the pixel mean value of each block of the at least one block is less than or equal to a first threshold, determining that the grayscale mapping curve function corresponding to each block of the at least one block is a curve function TRC1; and when the pixel mean value of each block of the at least one block is greater than the first threshold, determining that the grayscale mapping curve function corresponding to each block of the at least one block is a curve function TRC2; where the curve function TRC1 and the curve function TRC2 are used to adjust grayscale areas obtained by means of division according to different pixel values.

With reference to the first aspect, the first possible implementation manner of the first aspect, the second possible implementation manner of the first aspect, or the third possible implementation manner of the first aspect, in a fourth possible implementation manner, the adjusted pixel value pₒᵤₜ of the first pixel is determined according to the following equation:

$${p}_{out} = {\sum }_{i = 1}^{n} {p}_{r} ( {b}_{i} ) \times {TRC}_{{b}_{i}} ( {p}_{in} ) ,$$

where n indicates a quantity of the at least one block, n is a positive integer, pᵢₙ indicates the original pixel value of the first pixel, bᵢ indicates an i^{th} block of the at least one block, pᵣ(bᵢ) indicates a ratio of an area of a part covered by the mask and in the i^{th} block to the area of the mask, and TRC_{b}_{ᵢ}(pᵢₙ) indicates an output value of a grayscale mapping curve function corresponding to the i^{th} block when an input value is pᵢₙ.

According to a second aspect, an image processing device is provided and includes a first determining unit configured to determine at least one block covered by a mask and in a current frame image, where the mask uses a first pixel in the current frame image as a center, the at least one block is obtained by dividing the current frame image, and the block includes multiple pixels; a second determining unit configured to determine a pixel mean value of each block of the at least one block, and determine, according to the pixel mean value of each block of the at least one block, a grayscale mapping curve function corresponding to each block of the at least one block; a third determining unit configured to determine a ratio of an area of a part covered by the mask and in each block of the at least one block to an area of the mask; and a fourth determining unit, connected to the first determining unit, the second determining unit, and the third determining unit, and configured to determine an adjusted pixel value of the first pixel according to the ratio of the area of the part covered by the mask and in each block of the at least one block to the area of the mask, the grayscale mapping curve function corresponding to each block of the at least one block, and an original pixel value of the first pixel.

With reference to the second aspect, in a first possible implementation manner, the second determining unit is configured to acquire a pixel mean value of a block in a previous frame image and corresponding to each block of the at least one block; use the pixel mean value of the block in the previous frame image and corresponding to each block of the at least one block as the pixel mean value of each block of the at least one block; and determine, according to the pixel mean value of each block of the at least one block, the grayscale mapping curve function corresponding to each block of the at least one block.

With reference to the second aspect, in a second possible implementation manner, the second determining unit is configured to collect statistics on pixel values of all pixels of each block of the at least one block, to determine the pixel mean value of each block of the at least one block; and determine, according to the pixel mean value of each block of the at least one block, the grayscale mapping curve function corresponding to each block of the at least one block.

With reference to the second aspect, in a third possible implementation manner, the second determining unit is configured to determine the pixel mean value of each block of the at least one block; when the pixel mean value of each block of the at least one block is less than or equal to a first threshold, determine that the grayscale mapping curve function corresponding to each block of the at least one block is a curve function TRC1; and when the pixel mean value of each block of the at least one block is greater than the first threshold, determine that the grayscale mapping curve function corresponding to each block of the at least one block is a curve function TRC2; where the curve function TRC1 and the curve function TRC2 are used to adjust grayscale areas obtained by means of division according to different pixel values.

With reference to the second aspect, the first possible implementation manner of the second aspect, the second possible implementation manner of the second aspect, or the third possible implementation manner of the second aspect, in a fourth possible implementation manner, the fourth determining unit is configured to determine the adjusted pixel value pₒᵤₜ of the first pixel according to the following equation:

$${p}_{out} = {\sum }_{i = 1}^{n} {p}_{r} ( {b}_{i} ) \times {TRC}_{{b}_{i}} ( {p}_{in} ) ,$$

where n indicates a quantity of the at least one block, n is a positive integer, pᵢₙ indicates the original pixel value of the first pixel, bᵢ indicates an i^{th} block of the at least one block, pᵣ(bᵢ) indicates a ratio of an area of a part covered by the mask and in the i^{th} block to the area of the mask, and TRC_{b}_{ᵢ}(pᵢₙ) indicates an output value of a grayscale mapping curve function corresponding to the i^{th} block when an input value is pᵢₙ.

In the embodiments of the present invention, at least one block covered by a mask and in a current frame image is determined, and an adjusted pixel value of a first pixel is determined according to a ratio of an area of a part covered by the mask and in each block of the at least one block to an area of the mask, a grayscale mapping curve function corresponding to each block of the at least one block, and an original pixel value of the first pixel, so that normalization processing does not need to be performed on pixels in the mask, thereby saving resources and increasing an image processing speed.

### BRIEF DESCRIPTION OF THE DRAWINGS

To describe the technical solutions in the embodiments of the present invention more clearly, the following briefly introduces the accompanying drawings required for describing the embodiments of the present invention. The accompanying drawings in the following description show merely some embodiments of the present invention, and a person of ordinary skill in the art may still derive other drawings from these accompanying drawings without creative efforts.

FIG. 1 is a schematic flowchart of an image processing method according to an embodiment of the present invention;

FIG. 2 is a schematic diagram of an example of image processing according to an embodiment of the present invention;

FIG. 3 is a schematic diagram of an example of a grayscale mapping curve function according to an embodiment of the present invention;

FIG. 4 is a schematic diagram of another example of a grayscale mapping curve function according to an embodiment of the present invention;

FIG. 5 is a schematic block diagram of an image processing device according to an embodiment of the present invention; and

FIG. 6 is a schematic block diagram of an image processing device according to another embodiment of the present invention.

### DETAILED DESCRIPTION

The following clearly describes the technical solutions in the embodiments of the present invention with reference to the accompanying drawings in the embodiments of the present invention. The described embodiments are a part rather than all of the embodiments of the present invention. All other embodiments obtained by a person of ordinary skill in the art based on the embodiments of the present invention without creative efforts shall fall within the protection scope of the present invention.

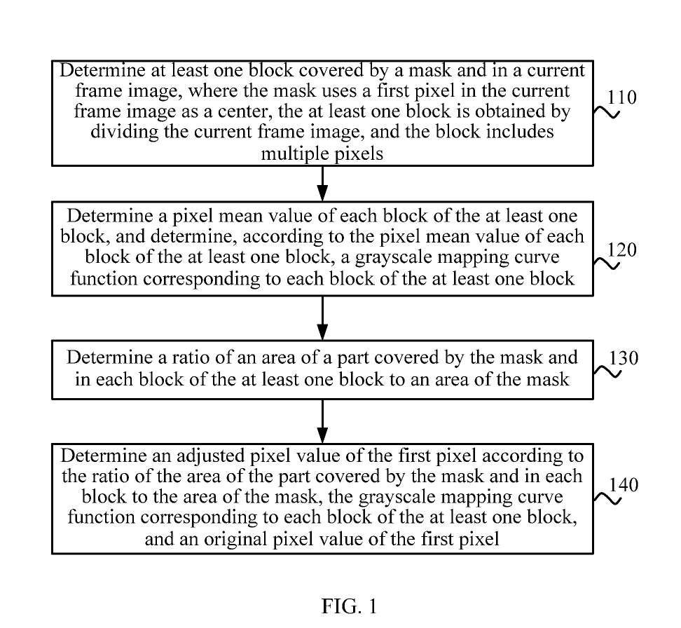

FIG. 1 is a schematic flowchart of an image processing method according to an embodiment of the present invention. The method in FIG. 1 is executed by an image processing device.

110. Determine at least one block covered by a mask and in a current frame image, where the mask uses a first pixel in the current frame image as a center, the at least one block is obtained by dividing the current frame image, and the block includes multiple pixels.

In this embodiment of the present invention, the at least one block covered by the mask and in the current frame image may include a block entirely covered by the mask and a block partially covered by the mask.

Optionally, in another embodiment, the current frame image may be divided before step 110. For example, the current frame image may be divided into multiple blocks according to such an actual situation as quality of the current frame image, and may be divided evenly or unevenly, which is not limited in this embodiment of the present invention. The block may include multiple pixels.

The first pixel is a pixel that needs to be processed currently. The mask uses the first pixel as the center, and a size of the mask may be determined according to such an actual situation as the quality of the current frame image.

120. Determine a pixel mean value of each block of the at least one block, and determine, according to the pixel mean value of each block of the at least one block, a grayscale mapping curve function corresponding to each block of the at least one block.

Optionally, in another embodiment, the foregoing step 120 may further include determining the pixel mean value of each block of the at least one block; when the pixel mean value of each block of the at least one block is less than or equal to a first threshold, determining that the grayscale mapping curve function corresponding to each block of the at least one block is a curve function TRC1; and when the pixel mean value of each block of the at least one block is greater than the first threshold, determining that the grayscale mapping curve function corresponding to each block of the at least one block is a curve function TRC2; where the curve function TRC1 and the curve function TRC2 are used to adjust grayscale areas obtained by means of division according to different pixel values.

For example, the first threshold may be 64. When a pixel mean value of a block is less than or equal to 64, it may be determined that a grayscale mapping curve function corresponding to the block is a curve function TRC1, which is used to adjust a shadow area of an image. When the pixel mean value of the block is greater than 64, it may be determined that the grayscale mapping curve function corresponding to the block is a curve function TRC2, which is used to adjust a highlight area of the image.

The pixel mean value is an average value of pixel values. The grayscale mapping curve function may be determined with reference to the prior art, for example, a basic S-shaped curve function may be adjusted according to information such as the quality of the current frame image, to obtain the grayscale mapping curve function. The grayscale mapping curve function may include two curve functions, or may include three or more curve functions, which is not limited in this embodiment of the present invention. For example, the grayscale mapping curve function may include two curve functions, which are respectively used to adjust a shadow area of an image (for example, the function may be the curve function TRC1) and a highlight area of the image (for example, the function may be the curve function TRC2). Alternatively, the grayscale mapping curve function may include three curve functions, which are respectively used to adjust a shadow area, an intermediate area, and a highlight area of an image, where the shadow area, the intermediate area, and the highlight area may be obtained by means of division according to pixel values.

Optionally, in an embodiment, a pixel mean value of a block is in a previous frame image and corresponding to each block of the at least one block may be acquired, the pixel mean value of the block in the previous frame image and corresponding to each block of the at least one block may be used as the pixel mean value of each block of the at least one block, and the grayscale mapping curve function corresponding to each block of the at least one block may be determined according to the pixel mean value of each block of the at least one block.

A division manner of the current frame image may be the same as a division manner of the previous frame image, so that the pixel mean value of each block of the at least one block covered by the mask and in the current frame image may be determined by calling data information of the previous frame image, that is, the pixel mean value of the block in the previous frame image and corresponding to each block of the at least one block, which is covered by the mask and is in the current frame image is used as the pixel mean value of each block of the at least one block covered by the mask and in the current frame image. In this way, information about the previous frame image can be directly called to process the current frame image, and no extra buffer is required, thereby saving resources, increasing an image processing speed, and facilitating hardware implementation.

Optionally, in another embodiment, statistics may be collected on pixel values of all pixels of each block of the at least one block, to determine the pixel mean value of each block of the at least one block, and the grayscale mapping curve function corresponding to each block of the at least one block may be determined according to the pixel mean value of each block of the at least one block.

130. Determine a ratio of an area of a part covered by the mask and in each block of the at least one block to an area of the mask.

140. Determine an adjusted pixel value of the first pixel according to the ratio of the area of the part covered by the mask and in each block of the at least one block to the area of the mask, the grayscale mapping curve function corresponding to each block of the at least one block, and an original pixel value of the first pixel.

The adjusted pixel value of the first pixel may refer to a pixel value obtained by processing the original pixel value of the first pixel, for example, in step 140, the original pixel value of the first pixel may be processed according to the ratio of the area of the part covered by the mask and in each block of the at least one block to the area of the mask, and the grayscale mapping curve function corresponding to each block of the at least one block, to obtain the adjusted pixel value of the first pixel.

Optionally, in another embodiment, the adjusted pixel value pₒᵤₜ of the first pixel may be determined according to the following equation:

$${p}_{out} = {\sum }_{i = 1}^{n} {p}_{r} ( {b}_{i} ) \times {TRC}_{{b}_{i}} ( {p}_{in} ) ,$$

where n indicates a quantity of the at least one block covered by the mask, n is a positive integer, pᵢₙ indicates the original pixel value of the first pixel, bᵢ indicates an i^{th} block of the at least one block, pᵣ(bᵢ) indicates a ratio of an area of a part covered by the mask and in the i^{th} block to the area of the mask, and TRC_{b}_{ᵢ}(pᵢₙ) indicates an output value of a grayscale mapping curve function corresponding to the i^{th} block when an input value is pᵢₙ.

It should be understood that the sequence numbers of the foregoing processes do not imply an execution sequence, and the execution sequence of the processes should be determined according to functions and internal logic of the processes, and shall not be construed as a limitation on an implementation process of this embodiment of the present invention. For example, step 120 may be executed after step 130, or may be executed concurrently with step 130.

In the prior art, when a mask is used to perform image processing, normalization processing needs to be performed on pixels in the mask, and then an adjusted pixel value of a pixel that needs to be processed currently is determined according to a result of the normalization. Consequently, calculation complexity is high, a lot of resources are occupied, and an image processing speed is low. In this embodiment of the present invention, each block of the at least one block covered by a mask and is in a current frame image is determined, and an adjusted pixel value of a first pixel is determined according to a ratio of an area of a part covered by the mask and in each block of the at least one block to an area of the mask, a grayscale mapping curve function corresponding to each block of the at least one block, and an original pixel value of the first pixel, so that normalization processing does not need to be performed on pixels in the mask, thereby saving resources, increasing an image processing speed, and facilitating hardware implementation. In addition, in this embodiment of the present invention, image processing is performed based on a statistical characteristic value of each block of the at least one block, for example, a pixel mean value of each block of the at least one block, or a grayscale mapping curve function corresponding to each block of the at least one block, and a size of the mask may also be determined according to a situation of the current frame image. Therefore, a size of a neighborhood of the first pixel may be simulated by adjusting a quantity of blocks covered by the mask, making an image processing process flexible, thereby ensuring an image processing effect.

In this embodiment of the present invention, at least one block covered by a mask and in a current frame image is determined, and an adjusted pixel value of a first pixel is determined according to a ratio of an area of a part covered by the mask and in each block of the at least one block to an area of the mask, a grayscale mapping curve function corresponding to each block of the at least one block, and an original pixel value of the first pixel, so that normalization processing does not need to be performed on pixels in the mask, thereby saving resources, increasing an image processing speed, and facilitating hardware implementation.

The following describes this embodiment of the present invention in detail with reference to specific examples. It should be noted that these examples are intended to help a person skilled in the art better understand this embodiment of the present invention, but are not intended to limit the scope of this embodiment of the present invention.

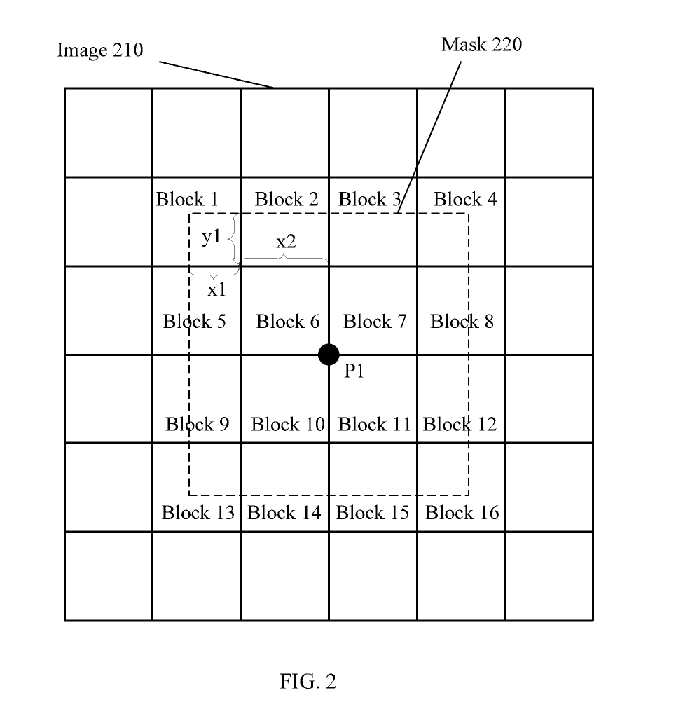

FIG. 2 is a schematic diagram of an example of image processing according to an embodiment of the present invention.

As shown in FIG. 2, an image 210 may be a current frame image. A first pixel P1 is a pixel that needs to be processed currently.

The image 210 may be divided into multiple blocks, for example, in FIG. 2, the image 210 may be divided into 6*6=36 blocks.

A mask 220 may use the first pixel P1 as a center, and a size of the mask 220 may be determined according to a parameter, such as quality of the image 210. For example, in FIG. 2, the size of the mask 220 may be 200*200. In this case, the mask 220 may cover 16 blocks, including blocks entirely covered by the mask 220 and blocks partially covered by the mask 220, where the blocks entirely covered by the mask 220 include block 6, block 7, block 10, and block 11, and the blocks partially covered by the mask 220 include block 1 to block 4, block 5, block 8, block 9, block 12, and block 13 to block 16.

A process of processing a pixel value of the first pixel P1 may be as follows.

1. Determine a pixel mean value of each block of the at least one block covered by the mask.

For example, statistics may be collected on pixel values of all pixels of each block of the at least one block, to determine the pixel mean value of each block of the at least one block.

In addition, pixel mean values of blocks in a previous frame image and corresponding to block 1 to block 16 may also be used as pixel mean values of block 1 to block 16. For example, a pixel mean value of each block of the at least one block in the previous frame image may be determined when the previous frame image is processed, and stored in a double data rate (DDR) synchronous dynamic random access memory (SDRAM). Therefore, the pixel mean values of the blocks in the previous frame image and corresponding to block 1 to block 16 may be acquired from the DDR SDRAM and used as the pixel mean values of block 1 to block 16. In this way, not only an image processing effect can be ensured, but also no extra buffer is required, thereby saving resources and increasing an image processing speed.

It is assumed that the determined pixel mean values of block 1 to block 16 are: 16, 36, 22, 88, 230, 163, 120, 222, 0, 66, 192, 206, 163, 255, 255, and 99, respectively.

2. Determine, according to the pixel mean values of block 1 to block 16, grayscale mapping curve functions corresponding to block 1 to block 16.

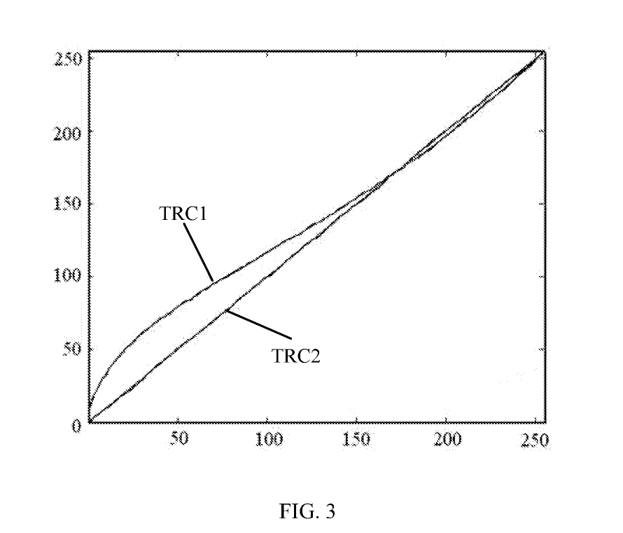

FIG. 3 is a schematic diagram of an example of a grayscale mapping curve function according to an embodiment of the present invention. The grayscale mapping curve function may be determined with reference to the prior art. As shown in FIG. 3, the grayscale mapping curve function includes a curve function TRC1 and a curve function TRC2. The curve function TRC1 may be used to adjust a shadow area, and the curve function TRC2 may be used to adjust a highlight area. The shadow area and the highlight area may be classified as follows:

0<pixel value≦64, the shadow area; and

64<pixel value≦255, the highlight area.

Curve functions corresponding to block 1 to block 16 may be determined according to the pixel mean values of block 1 to block 16.

For example, if the pixel mean value of block 1 is 16, which belongs to the shadow area, block 1 corresponds to the curve function TRC1. A manner of determining curve functions corresponding to block 2 to block 16 is similar, and to avoid repetition, details are not described herein again.

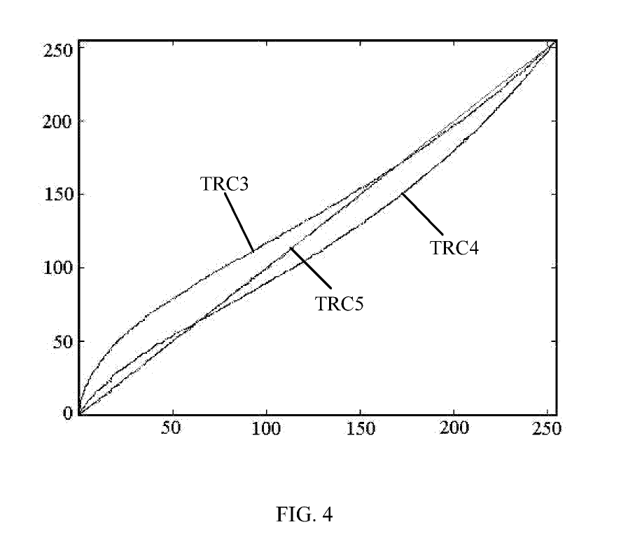

FIG. 4 is a schematic diagram of another example of a grayscale mapping curve function according to an embodiment of the present invention. As shown in FIG. 4, the grayscale mapping curve function may include a curve function TRC3, a curve function TRC4, and a curve function TRC5. The curve function TRC3 may be used to adjust a shadow area, the curve function TRC4 may be used to adjust an intermediate area, and the curve function TRC5 may be used to adjust a highlight area. The shadow area, the intermediate area, and the highlight area may be classified as follows:

0<pixel value≦64, the shadow area;

64<pixel value≦192, the intermediate area; and

192<pixel value≦255, the highlight area.

Curve functions corresponding to block 1 to block 16 may be determined according to the pixel mean values of block 1 to block 16. For example, if the pixel mean value of block 1 is 16, which belongs to the shadow area, block 1 corresponds to the curve function TRC3. For example, if the pixel mean value of block 4 is 88, which belongs to the intermediate area, block 4 corresponds to the curve function TRC4. A manner of determining curve functions corresponding to other blocks is similar, and to avoid repetition, details are not described herein again.

3. Determine a ratio of an area of a part covered by the mask 220 and in each block of block 1 to block 16 to an area of the mask 220.

For example, as shown in FIG. 3, an area of a part covered by the mask 220 and in block 1 is x1*y1. In this case, a ratio of the area of the part covered by the mask 220 and in block 1 to the area of the mask 220 is Pᵣ(block 1)=(x1*y1)/(200*200); and a ratio of an area of a part covered by the mask 220 and in block 2 to the area of the mask 220 is Pᵣ(block 2)=(x2*y1)/(200*200). A manner of determining ratios of areas of parts covered by the mask 220 and in block 3 to block 16 to the area of the mask 220 is similar, and to avoid repetition, details are not described herein again.

4. Determine an adjusted pixel value Pₒᵤₜ of the first pixel P1.

It is assumed that an original pixel value of the first pixel P1 is Pᵢₙ; according to the example of the grayscale mapping curve function in FIG. 3, the adjusted pixel value Pₒᵤₜ of the first pixel P1 may be determined according to the following equation:

Pₒᵤₜ=Pᵣ(block 1)*TRC1(Pᵢₙ)+Pr(block 2)*TRC1(Pᵢₙ)+Pr(block 3)*TRC1(Pᵢₙ)+Pr(block 4)*TRC2(Pᵢₙ)+ . . . +Pᵣ(block 16)*TRC2(Pᵢₙ),

where TRC1(Pᵢₙ) may indicate an output value corresponding to the curve function TRC1 when an input value is Pᵢₙ. TRC2(Pᵢₙ) may indicate an output value corresponding to the curve function TRC2 when the input value is Pᵢₙ.

In this embodiment of the present invention, at least one block covered by a mask and in a current frame image is determined, and an adjusted pixel value of a first pixel is determined according to a ratio of an area of a part covered by the mask and in each block of the at least one block to an area of the mask, a grayscale mapping curve function corresponding to each block of the at least one block, and an original pixel value of the first pixel, so that normalization processing does not need to be performed on pixels in the mask, thereby saving resources, increasing an image processing speed, and facilitating hardware implementation.

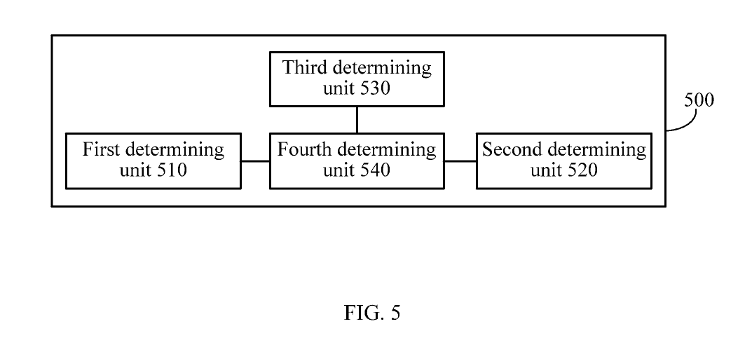

FIG. 5 is a schematic block diagram of an image processing device according to an embodiment of the present invention. A device 500 in FIG. 5 includes a first determining unit 510, a second determining unit 520, a third determining unit 530, and a fourth determining unit 540. An example of the device 500 may be a decoder or an image signal processor. In addition, the device 500 may further be a product in another form, which is not limited in this embodiment of the present invention.

The first determining unit 510 determines at least one block covered by a mask and in a current frame image, where the mask uses a first pixel in the current frame image as a center, the at least one block is obtained by dividing the current frame image, and the block includes multiple pixels. The second determining unit 520 determines a pixel mean value of each block of the at least one block, and determines, according to the pixel mean value of each block of the at least one block, a grayscale mapping curve function corresponding to each block of the at least one block. The third determining unit 530 determines a ratio of an area of a part covered by the mask and in each block of the at least one block to an area of the mask. The fourth determining unit 540 is connected to the first determining unit 510, the second determining unit 520, and the third determining unit 530, and determines an adjusted pixel value of the first pixel according to the ratio of the area of the part covered by the mask and in each block of the at least one block to the area of the mask, the grayscale mapping curve function corresponding to each block of the at least one block, and an original pixel value of the first pixel.

In this embodiment of the present invention, at least one block covered by a mask and in a current frame image is determined, and an adjusted pixel value of a first pixel is determined according to a ratio of an area of a part covered by the mask and in each block of the at least one block to an area of the mask, a grayscale mapping curve function corresponding to each block of the at least one block, and an original pixel value of the first pixel, so that normalization processing does not need to be performed on pixels in the mask, thereby saving resources, increasing an image processing speed, and facilitating hardware implementation.

For other functions and operations of the device 500, refer to the processes of the foregoing method embodiments of FIG. 1 to FIG. 4, and to avoid repetition, details are not described herein again.

Optionally, in an embodiment, the second determining unit 520 may acquire a pixel mean value of a block in a previous frame image and corresponding to each block of the at least one block, use the pixel mean value of the block in the previous frame image and corresponding to each block of the at least one block as the pixel mean value of each block of the at least one block, and determine, according to the pixel mean value of each block of the at least one block, the grayscale mapping curve function corresponding to each block of the at least one block.

Optionally, in another embodiment, the second determining unit 520 may collect statistics on pixel values of all pixels of each block of the at least one block, to determine the pixel mean value of each block of the at least one block, and determine, according to the pixel mean value of each block of the at least one block, the grayscale mapping curve function corresponding to each block of the at least one block.

Optionally, in another embodiment, the second determining unit 520 may determine the pixel mean value of each block of the at least one block; when the pixel mean value of each block of the at least one block is less than or equal to a first threshold, determine that the grayscale mapping curve function corresponding to each block of the at least one block is a curve function TRC1; and when the pixel mean value of each block of the at least one block is greater than the first threshold, determine that the grayscale mapping curve function corresponding to each block of the at least one block is a curve function TRC2; where the curve function TRC1 and the curve function TRC2 may be used to adjust grayscale areas divided according to different pixel values.

Optionally, in another embodiment, the fourth determining unit 540 may determine the adjusted pixel value pₒᵤₜ of the first pixel according to the following equation:

$${p}_{out} = {\sum }_{i = 1}^{n} {p}_{r} ( {b}_{i} ) \times {TRC}_{{b}_{i}} ( {p}_{in} ) ,$$

where n indicates a quantity of the at least one block, n is a positive integer, pᵢₙ indicates the original pixel value of the first pixel, bᵢ indicates an i^{th} block of the at least one block, pᵣ(b,) indicates a ratio of an area of a part covered by the mask and in the i^{th} block to the area of the mask, and TRC_{b}_{ᵢ}(pᵢₙ) indicates an output value corresponding to a grayscale mapping curve function corresponding to the i^{th} block when an input value is pᵢₙ.

In this embodiment of the present invention, at least one block covered by a mask and in a current frame image is determined, and an adjusted pixel value of a first pixel is determined according to a ratio of an area of a part covered by the mask and in each block of the at least one block to an area of the mask, a grayscale mapping curve function corresponding to each block of the at least one block, and an original pixel value of the first pixel, so that normalization processing does not need to be performed on pixels in the mask, thereby saving resources, increasing an image processing speed, and facilitating hardware implementation.

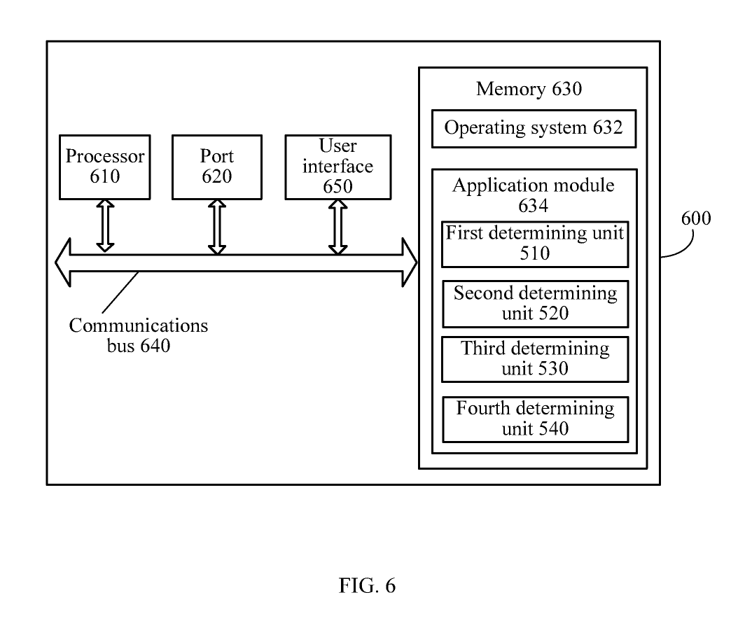

FIG. 6 is a schematic block diagram of an image processing device according to another embodiment of the present invention.

As shown in FIG. 6, a device 600 generally includes at least one processor 610, for example, a central processing unit (CPU), at least one port 620, a memory 630, and at least one communications bus 640. The communications bus 640 is configured to implement connection and communication between these apparatuses. The processor 610 is configured to execute an executable module stored in the memory 630, for example, a computer program. Optionally, the device 600 may include a user interface 650, where the user interface 650 includes but is not limited to a display, a keyboard, and a pointing device, such as a mouse, a trackball, a touchpad, or a touch display screen. The memory 630 may include a high-speed random-access memory (RAM), or may further include a non-volatile memory, for example, at least one magnetic disk memory.

In some implementation manners, the memory 630 stores the following elements, executable modules or data structures, or a subset thereof, or an extended set thereof: an operating system 632, including various system programs, used to implement various basic services and process hardware-based tasks; and an application module 634, including various application programs, used to implement various application services.

The application module 634 includes but is not limited to a first determining unit 510, a second determining unit 520, a third determining unit 530, and a fourth determining unit 540.

For specific implementation of units in the application module 634, refer to corresponding units in the embodiment shown in FIG. 5, and details are not described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are executed by hardware or software depends on particular applications and design constraint conditions of the technical solutions. A person skilled in the art may use different methods to implement the described functions for each particular application, but it shall not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected as required to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or a part of the technical solutions may be implemented in a form of a software product. The computer software product is stored in a storage medium, and includes several instructions for instructing a computer device (which may be a personal computer, a server, a network device, or the like) to execute all or a part of the steps of the methods described in the embodiments of the present invention. The foregoing storage medium includes any medium that can store program code, such as a universal serial bus (USB) flash drive, a removable hard disk, a read-only memory (ROM), a RAM, a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An image processing method, comprising:
determining at least one block covered by a mask and in a current frame image, wherein the mask uses a first pixel in the current frame image as a center, the at least one block is obtained by dividing the current frame image, and the block comprises multiple pixels;
determining a pixel mean value of each block of the at least one block;
determining, according to the pixel mean value of each block of the at least one block, a grayscale mapping curve function corresponding to each block of the at least one block;
determining a ratio of an area of a part covered by the mask and in each block of the at least one block to an area of the mask; and
determining an adjusted pixel value of the first pixel according to the ratio of the area of the part covered by the mask and in each block of the at least one block to the area of the mask, the grayscale mapping curve function corresponding to each block of the at least one block, and an original pixel value of the first pixel.

2. The method according to claim 1, wherein determining the pixel mean value of each block of the at least one block, and determining, according to the pixel mean value of each block of the at least one block, the grayscale mapping curve function corresponding to each block of the at least one block comprises:
acquiring a pixel mean value of a block in a previous frame image and corresponding to each block of the at least one block;
using the pixel mean value of the block in the previous frame image and corresponding to each block of the at least one block as the pixel mean value of each block of the at least one block; and
determining, according to the pixel mean value of each block of the at least one block, the grayscale mapping curve function corresponding to each block of the at least one block.

3. The method according to claim 1, wherein determining the pixel mean value of each block of the at least one block, and determining, according to the pixel mean value of each block of the at least one block, the grayscale mapping curve function corresponding to each block of the at least one block comprises:
collecting statistics on pixel values of all pixels of each block of the at least one block, to determine the pixel mean value of each block of the at least one block; and
determining, according to the pixel mean value of each block of the at least one block, the grayscale mapping curve function corresponding to each block of the at least one block.

4. The method according to claim 1, wherein determining the pixel mean value of each block of the at least one block, and determining, according to the pixel mean value of each block of the at least one block, the grayscale mapping curve function corresponding to each block of the at least one block comprises:
determining the pixel mean value of each block of the at least one block;
determining that the grayscale mapping curve function corresponding to each block of the at least one block is a curve function TRC1 when the pixel mean value of each block of the at least one block is less than or equal to a first threshold; and
determining that the grayscale mapping curve function corresponding to each block of the at least one block is a curve function TRC2 when the pixel mean value of each block of the at least one block is greater than the first threshold, wherein the curve function TRC1 and the curve function TRC2 are used to adjust grayscale areas obtained by means of division according to different pixel values.

5. The method according to claim 1, wherein determining the adjusted pixel value of the first pixel according to the ratio of the area of the part covered by the mask and in each block of the at least one block to the area of the mask, the grayscale mapping curve function corresponding to each block of the at least one block, and the original pixel value of the first pixel comprises:
determining the adjusted pixel value pₒᵤₜ of the first pixel according to the following equation:
$${p}_{out} = {\sum }_{i = 1}^{n} {p}_{r} ( {b}_{i} ) \times {TRC}_{{b}_{i}} ( {p}_{in} ) ,$$
wherein n indicates a quantity of the at least one block, n is a positive integer, pᵢₙ indicates the original pixel value of the first pixel, bᵢ indicates an i^{th} block of the at least one block, pᵣ(bᵢ) indicates a ratio of an area of a part covered by the mask and in the i^{th} block to the area of the mask, and TRC_{b}_{ᵢ}(pᵢₙ) indicates an output value of a grayscale mapping curve function corresponding to the i^{th} block when an input value is pᵢₙ.

6. An image processing device, comprising:
a first determining unit configured to determine at least one block covered by a mask and in a current frame image, wherein the mask uses a first pixel in the current frame image as a center, the at least one block is obtained by dividing the current frame image, and the block comprises multiple pixels;
a second determining unit configured to determine a pixel mean value of each block of the at least one block, and determine, according to the pixel mean value of each block of the at least one block, a grayscale mapping curve function corresponding to each block of the at least one block;
a third determining unit configured to determine a ratio of an area of a part covered by the mask and in each block of the at least one block to an area of the mask; and
a fourth determining unit connected to the first determining unit, the second determining unit, and the third determining unit, and configured to determine an adjusted pixel value of the first pixel according to the ratio of the area of the part covered by the mask and in each block of the at least one block to the area of the mask, the grayscale mapping curve function corresponding to each block of the at least one block, and an original pixel value of the first pixel.

7. The device according to claim 6, wherein the second determining unit is configured to:
acquire a pixel mean value of a block in a previous frame image and corresponding to each block of the at least one block;
use the pixel mean value of the block in the previous frame image and corresponding to each block of the at least one block as the pixel mean value of each block of the at least one block; and
determine, according to the pixel mean value of each block of the at least one block, the grayscale mapping curve function corresponding to each block of the at least one block.

8. The device according to claim 6, wherein the second determining unit is configured to:
collect statistics on pixel values of all pixels of each block of the at least one block, to determine the pixel mean value of each block of the at least one block; and
determine, according to the pixel mean value of each block of the at least one block, the grayscale mapping curve function corresponding to each block of the at least one block.

9. The device according to claim 6, wherein the second determining unit is configured to:
determine the pixel mean value of each block of the at least one block;
determine that the grayscale mapping curve function corresponding to each block of the at least one block is a curve function TRC1 when the pixel mean value of each block of the at least one block is less than or equal to a first threshold; and
determine that the grayscale mapping curve function corresponding to each block of the at least one block is a curve function TRC2 when the pixel mean value of each block of the at least one block is greater than the first threshold, wherein the curve function TRC1 and the curve function TRC2 are used to adjust grayscale areas obtained by means of division according to different pixel values.

10. The device according to claim 6, wherein the fourth determining unit is configured to determine the adjusted pixel value pₒᵤₜ of the first pixel according to the following equation:
$${p}_{out} = {\sum }_{i = 1}^{n} {p}_{r} ( {b}_{i} ) \times {TRC}_{{b}_{i}} ( {p}_{in} ) ,$$
wherein n indicates a quantity of the at least one block, n is a positive integer, pᵢₙ indicates the original pixel value of the first pixel, bᵢ indicates an i^{th} block of the at least one block, pᵣ(bᵢ) indicates a ratio of an area of a part covered by the mask and in the block to the area of the mask, and TRC_{b}_{ᵢ}(pᵢₙ) indicates an output value of a grayscale mapping curve function corresponding to the i^{th} block when an input value is pᵢₙ.
